(19) United States
(12) Patent Application Publication
(10) Pub. No.: US 2003/0202220 A1
(43) Pub. Date: Oct. 30, 2003

(54) Holding scanned documents by a digital sending device

(76) Inventor: Robert Sesek, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/133,606

(22) Filed: Apr. 26, 2002

(51) Int. Cl. H04N 1/00; H04N 1/04

(52) U.S. Cl. 358/474; 358/405

(57) ABSTRACT

A digital sending device provides scanning of documents and transmission of those scanned documents to a designated digital receiving device. When a document is scanned into the digital sending device, a user is given the ability to delay transmission of the scanned document until specified conditions have been satisfied. In one embodiemnt, if the specified conditions have not been satisfied, the scanned document is buffered to memory or secondary storage by the digital sending device until the specified conditions have been satisfied. At that time, the buffered, scanned document is transmitted across the data network from the digital sending device to the designated digital receiving device.

### FIELD OF THE INVENTION

The present invention generally relates to digital communications and, more specifically, to the digitally sending of scanned documents which are held for sending until a specified condition is satisfied.

### BACKGROUND OF THE INVENTION

Modem businesses rely on being able to transfer document images from one location to another. With the adoption of Group 3 digital standards in 1980 by the Comité Consultatif International Téléphonique et Télégraphique (CCITT) (or the International Telegraph and Telephone Consultative Committee), facsimile (FAX) devices have become extremely prevalent in offices. Facsimile devices typically operate by scanning a document line by line to detect light and dark areas. These light and dark areas are then converted into binary digits. A representation of these light and dark areas is then transmitted across a telephone line to a receiving unit that in turn uses the received representation to generate dots on paper. The result is a reasonably good copy of the original document. Originally, facsimile printers typically utilized thermal paper imaging. More recently, laser and ink jet printing of incoming facsimile copies has become common. Also, many computer modems support the Group 3 digital standard, and thus allow computers to operate both to send and to receive facsimile copies of documents.

Facsimile transmission of copies of documents works reasonably well. However, a number of problems have been identified. One problem that has been identified is that facsimile copies often do not provide the level of image resolution that some applications require. Another problem is that facsimile transmissions typically consume more transmission bandwidth than may be necessary. This is compounded by the problem that, in most cases, facsimile transmissions utilize an entire circuit switched connection, as contrasted to sharing of circuits as is found in packet switching solutions.

One solution to these problems that has been found arose naturally from the use in many instances of computers on both ends of facsimile transmissions. On one end of a connection, a computer emulates a facsimile transmitter, and on the other end, another computer emulates a facsimile receiver. Standard computer scanners can be utilized to scan in documents. Similarly, standard computer printers can be utilized to print out received documents. In between, digital images of the documents are converted to the required Group 3 standard format before transmission, and then converted from the Group 3 standard to a standard computer output format before being printed.

One solution is termed “Digital Sending”. Digital sending eliminates the conversions from and to the Group 3 standard. Instead, a document is scanned into a standard internal computer image format, such as Portable Document Format (PDF) from Adobe Systems Incorporated, Tagged Image File Format (TIFF), Joint Photographic Experts Group (JPEG) format, Bit-Map (BMP) format from Microsoft Corporation, etc. The document is then transmitted to a receiving system in the specified internal computer image format, where it can be manipulated, stored, or printed, as desired. While a transmission can be over a circuit switched network, it is more frequently done over a packet switched network, such as the Internet, or a corporate intranet. Typically, documents are transmitted as email file attachments.

Originally, digital sending mirrored the typical email environment. An email message with one or more attached documents would be sent from one computer to another. However, as the cost of processing power continues to decline, it has become cost effective to utilize commodity processors in some auxiliary or peripheral devices such as printers and scanners. At the same time, these auxiliary devices are frequently being connected directly to networks instead of computers in order to more easily provide sharing of such among multiple computers and computer users. One result of this is that these auxiliary devices can now support functions such as email that previously were limited to computers.

The incorporation of email capabilities within auxiliary devices such as printers and scanners allows these devices to be utilized in digital sending. A scanner can be used to scan a document into a specified format, and then to transmit that document as an email attachment to a recipient. Similarly, a printer can receive an email containing a document in a particular format and print it out. Especially useful for digital sending are all-in-one or multifunction devices that provide scanning and printing, and even facsimile transmissions. Some current examples of stand-alone devices capable of digital sending and/or receiving are the 9100C digital sending device and the LaserJet 8150 multifunction device from Hewlett-Packard Company of Palo Alto, Calif.

One feature that would be advantageous would be to be able to delay or hold transmission of a scanned document until a prespecified condition has been satisfied.

### BRIEF SUMMARY OF THE INVENTION

The present invention provides for scanning of documents and transmission of those scanned documents to a designated digital receiving device. When a document is scanned into the digital sending device, a user is given the ability to delay transmission of the scanned document until specified conditions have been satisfied. In one embodiment, if the specified conditions have not been satisfied, the scanned document is buffered to memory or secondary storage by the digital sending device until the specified conditions have been satisfied. At that time, the buffered, scanned document is transmitted across the data network from the digital sending device to the designated digital receiving device.

### BRIEF DESCRIPTION OF THE DRAWINGS

FIG. 1 is a block diagram of an exemplary digital sending device;

FIG. 2 is a block diagram illustrating a network containing a digital sending device, in accordance with a preferred embodiment of the present invention; and

FIG. 3 is a flowchart that illustrates an exemplary operation of the present invention.

### DETAILED DESCRIPTION OF THE INVENTION

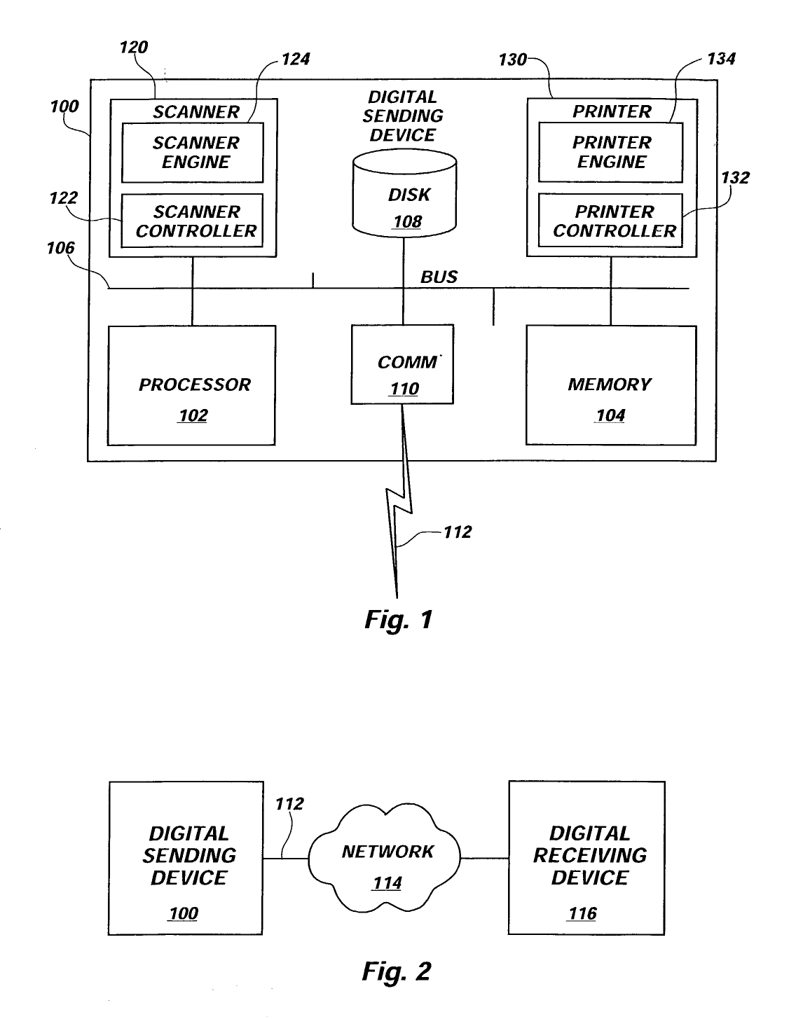

FIG. 1 is a block diagram of an exemplary digital sending device 100. The digital sending device 100 preferably comprises: a processor 102, memory 104, scanner components 120, printer components 130, and a communications interface 110, all coupled by a bus 106. Also, alternatively included in the digital sending device 100 and coupled to the other components by the bus 106 is secondary storage 108.

The memory 104 is a relatively high-speed, machine-readable medium and comprises volatile memories, such as DRAM and SRAM, and/or non-volatile memories, such as ROM, FLASH, EPROM, and EEPROM. Secondary storage 108 includes machine-readable media such as: hard disk drives (or DASD) and disk subsystems, floppy disks, removable hard drives, magnetic tapes, CD-ROM, and/or other computers, possibly connected via a communications line. Computer instructions comprising software such as digital sending device 100 control software can be stored in a computer instruction storage medium such as volatile memory, non-volatile memory, or secondary storage. Executable versions of computer instructions can be read from a computer readable storage medium such as secondary storage and non-volatile memory and loaded for execution directly into volatile memory, executed directly out of nonvolatile memory, or stored on the secondary storage prior to loading into volatile memory for execution.

The scanner components 120 comprise scanner control logic 122 and a scanner engine 124. The scanner control logic 122 controls the operation of the scanner engine 124. The printer components 130 comprise printer control logic 132 and a printer engine 134. The printer control logic 132 controls the operation of a printer engine 134. The scanner engine 124 and the printer engine 134 are the electromechanical portions of the scanner components 120 and printer components 130, respectively.

The processor 102 is preferably a commodity processor, such as a MIPS® RISC processor currently utilized by Hewlett-Packard Company of Palo Alto, Calif. in some of its multifunction printer devices. Alternatively, the processor 102 may be a custom processor. The processor 102 controls operation of the digital sending device 100 through execution of computer instructions fetched from memory 104.

The communications interface 110 provides communications between the digital sending device 100 and other computers and devices. Typically, the communications interface 110 provides an electronic and protocol interface to a communications link 112. In the preferred embodiment, the communications link 112 is to a local area network such as an Ethernet network. However, other types of communications links 112 are also within the scope of this invention. For example, the communications link 112 may utilize a DB25/Centronics parallel interface to a computer.

The configuration shown in FIG. 1 is illustrative only. Other configurations are also within the scope of this invention. For example, either the printer components 130 or the scanner components 120 may not be present. Also, the printer control logic 132 and the scanner control logic 122 are shown as separate components from the processor 102. However, this is illustrative only. Some or all of the functionality of the printer control logic 132 and the scanner control logic 122 may be implemented as computer instructions executed by the processor 102. Similarly, though the communications interface 110 is shown as a separate component, it may also be implemented utilizing a portion of the cycles of the processor 102.

FIG. 2 is a block diagram illustrating a network containing a digital sending device 100, in accordance with a preferred embodiment of the present invention. A digital sending device 100 is coupled via a communications link 112 to a single digital network 114. Also coupled to the single digital network 114 is a digital receiving device 116, which is the designated recipient of a digitally sent document from the digital sending device 100. A digital receiving device 116 is typically a server that is capable of storing documents until being retrieved by users. In the case of a document sent as an email attachment, the digital receiving device 116 will typically be an email server. However, a digital receiving device 116 may be the ultimate destination of a scanned document. Regardless, a document scanned into the digital sending device 100 will be transmitted across the single digital network 114 to the digital receiving device 116.

FIG. 2 shows a single digital network 114. This is illustrative only. Other configurations are also within the scope of this invention. The single digital network 114 may represent a plurality of actual networks. For example, the digital sending device 100 may contain or be coupled to a wireless data transceiver for transmission of data across a short distance wireless data network such as a Bluetooth network. The digital sending device 100 could then transmit a scanned document to a wireless data hub attached to a physical network such as a corporate Ethernet intranet. The scanned document could then be transmitted across this corporate intranet to an Internet gateway or firewall, where it would then be transmitted across the Internet. It might then cross another Internet gateway or firewall and enter another corporate intranet, to which is connected the designated digital receiving device 116.

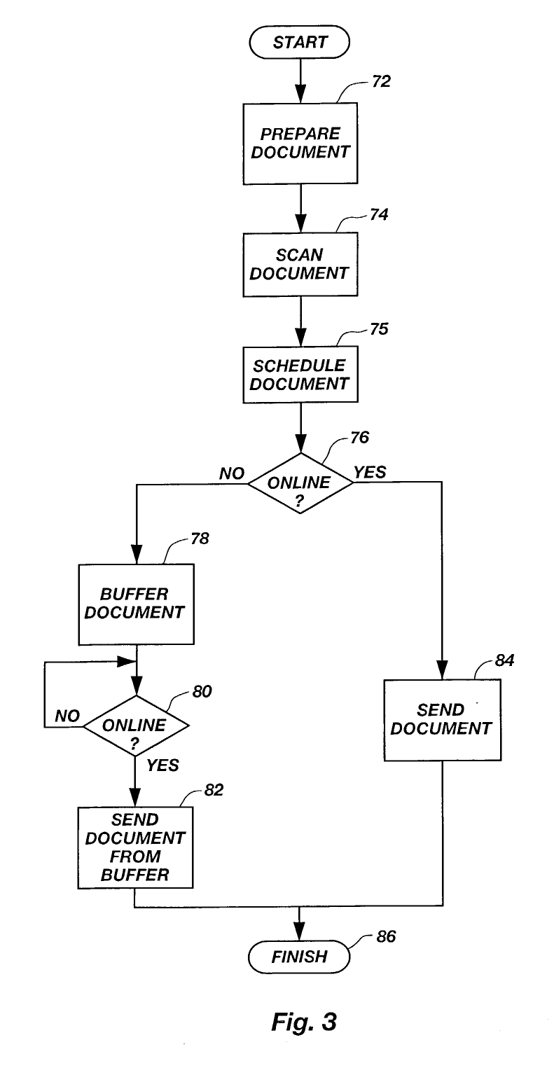

FIG. 3 is a flowchart that illustrates an exemplary operation of the present invention. First, a document is prepared, step 72, for facsimile transmission and is scanned, step 74, into a digital sending device 100. The user is also given a chance to specify conditions, which, when satisfied, will allow transmitting of the scanned document to the digital receiving device 116, step 75. A test is then made as to whether the specified conditions have been satisfied, step 76. If the digital sending device 100 has satisfied the specified conditions, step 76, then the document just scanned 74 is transmitted to the digital receiving device 116, step 84. Otherwise, a copy of the document to be sent is buffered to memory or secondary storage, step 78. A loop is then entered and a test is made as to whether the digital sending device 100 has satisfied the specified conditions, step 80. If the specified conditions have not been satisfied, the loop repeats, until the specified conditions are finally satisfied, step 80. At that point, the document previously buffered to memory or secondary storage is transmitted to the digital receiving device 116, step 82. The operation is then complete, step 86.

One type of condition that can be utilized for holding in steps 76 and 80 is time. The transmission of a scanned document from a digital sending device 100 to a digital receiving device 116 can be delayed until a specified date and/or time. This is illustrative only, and other types of hold conditions are also within the scope of this invention, such as, for example, holding a scan job until: a specified time has elapsed; temperature or other environmental variable has reached a specified limit; another scan job has been sent; confirmation of receipt of a previously sent scan job; stock price limits have been reached; and specified email or other software or hardware interrupt received. A user may also set a manual hold that can be manually released.

Physical implementation of a digital sending device supporting various types of hold conditions typically will depend on which hold conditions are being implemented. For example, commodity processors 102 typically contain a plurality of clocks. Operating systems executing on such, such as Linux® that can run on a MIPS® RISC processor, typically provide multiple tools to utilize these clocks. On the other hand, some of the hold conditions disclosed above require hardware sensing devices, such as a thermometer. Lower cost sensing devices can be coupled to the digital sending device 100 through a serial communications port that is coupled to the bus 108. More expensive sensing devices may directly connect to a bus 108. In either case, standard processor architectural facilities would typically be utilized to access these sensing devices. Alternatively, these sensing devices may be connected or coupled to other devices that can provide an electronic notification of status. For example, a remote system may send an email to the digital sending device 100 being utilized.

In its simpler form, a user can delay transmission of a scan job until a single specified condition has occurred. However, the present invention also includes holding for multiple conditions, preferably combined with standard Boolean operators. Thus, a scan job can be held for either condition A OR condition B to have occurred. Another scan job can be held until both condition C AND condition D have occurred. This is illustrative only. The present invention includes other and more complex methods of conditionally holding scan jobs for transmission.

FIG. 3 shows a “fast” or spinning loop for detecting when the specified conditions have been satisfied, step 80. This is illustrative only. The type of condition being tested typically determines the most efficient method of implementing the scan job hold functionality. For example, some operating systems provide an event time or schedule queue where events are scheduled to occur at some time in the future. In such a situation, scheduled time holds can be scheduled as events. Then, when these events are dispatched or received, the corresponding hold condition can be released. Other types of hold conditions may be better implemented through periodic probing. For example, in the case of a temperature hold, a thermometer may be read on a periodic basis, such as every minute, until the specified temperature is reached. Other methods of determining whether a hold condition has been satisfied are also within the scope of this invention.

The number of documents that can be buffered depends on how much space is available, and this to some extent depends on the medium to which the documents are buffered. Typically, secondary storage 108 provides substantially more storage space for buffered, scanned documents than does memory 104. Also, when secondary storage 108 is utilized to buffer documents to be sent as email attachments, the email and their attachments can be buffered in an outgoing email spool. In the case of buffering to memory, either a portion of the digital sending device's main memory 104 can be utilized or a separate buffering memory may be utilized (not shown). In the case of using memory 104 to buffer outgoing scanned documents, the documents may be buffered again as an outgoing email spool, or in a memory buffer format.

Scanned documents can therefore be buffered by a digital sending device 100 when specified hold conditions have not yet been satisfied. Each buffered, scanned document is then transmitted from the digital sending device 100 to its specified digital receiving device 116 when the corresponding hold conditions for those documents have been satisfied. This provides a mechanism to finely control the timing of transmissions of scanned documents from a digital sending device 100 to their intended recipients.

Those skilled in the art will recognize that modifications and variations can be made without departing from the spirit of the invention. Therefore, it is intended that this invention encompass all such variations and modifications as fall within the scope of the appended claims.

What is claimed is:

1. A method of holding scanned documents until a specified condition is satisfied comprising:
determining whether a set of conditions for a scanned document have been satisfied; and
transmitting the scanned document to a digital receiving device if the set of conditions for the scanned document have been determined to be satisfied.

2. The method in claim 1 which further comprises:
buffering the scanned document as a buffered document for a later transmission to the digital receiving device if the set of conditions for the scanned document have been determined not to be satisfied.

3. The method in claim 2 which further comprises:
detecting when the set of conditions for the scanned document have been satisfied; and
transmitting the buffered document to the digital receiving device after the set of conditions for the scanned document have been detected to have been satisfied.

4. The method in claim 1 wherein:
the set of conditions for the scanned document comprises:
a specified time of day.

5. The method in claim 1 wherein:
the set of conditions for the scanned document comprises:
an elapsed time.

6. The method in claim 1 wherein:
the set of conditions for the scanned document comprises:
a specified temperature limit.

7. The method in claim 1 wherein:
the set of conditions for the scanned document comprises:
a notification of an occurrence of an external event.

8. The method in claim 1 wherein:
the set of conditions for the scanned document comprises:
a first condition and a second condition wherein both the first condition and the second condition must be satisfied.

9. The method in claim 1 wherein:
the set of conditions for the scanned document comprises:
a first condition and a second condition wherein either the first condition or the second condition must be satisfied.

10. A method of holding scanned documents until a specified condition is satisfied comprising:
determining whether a set of conditions for a first scanned document have been satisfied;
transmitting the first scanned document to a digital receiving device if the set of conditions for the first scanned document have been determined to be satisfied;
determining whether a set of conditions for a second scanned document have been satisfied; and
transmitting the second scanned document to a second digital receiving device if the set of conditions for the second scanned document have been determined to be satisfied.

11. A digital sending device capable of holding scanned documents until a specified condition is satisfied comprising:
a processor capable of executing computer instructions;
a memory coupled to the processor; and
a computer instruction storage medium coupled to the processor and to the memory and containing computer instructions for:
determining whether a set of conditions for a first scanned document have been satisfied; and
transmitting the first scanned document to a first digital receiving device if the set of conditions for the first scanned document have been determined to be satisfied.

12. The digital sending device in claim 11 wherein the computer instruction storage medium further contains computer instructions for:
buffering the first scanned document as a first buffered document for a later transmission to the first digital receiving device if the set of conditions for the first scanned document have been determined not to be satisfied.

13. The digital sending device in claim 12 wherein the computer instruction storage medium further contains computer instructions for:
detecting when the set of conditions for the first scanned document have been satisfied; and
transmitting the first buffered document to the first digital receiving device after the set of conditions for the first scanned document have been detected to have been satisfied.

14. The digital sending device in claim 12 which further comprises:
a scanner coupled to the processor and to the memory and capable of scanning a document as the first scanned document.

15. The digital sending device in claim 12 wherein:
the computer instructions for buffering the first scanned document comprise buffering the first scanned document in the memory.

16. The digital sending device in claim 11 which further comprises:
a secondary storage medium capable of buffering the first scanned document.

17. The digital sending device in claim II wherein the computer instruction storage medium further contains computer instructions for:
scanning a document as the first scanned document.

18. The digital sending device in claim 11 wherein the computer instruction storage medium further contains computer instructions for:
determining whether a set of conditions for a second scanned document have been satisfied; and
transmitting the second scanned document to a second digital receiving device if the set of conditions for the second scanned document have been determined to be satisfied.

19. A method of holding scanned documents until a specified condition is satisfied comprising:
determining whether a set of conditions for a first scanned document have been satisfied;
transmitting the first scanned document to a digital receiving device if the set of conditions for the first scanned document have been determined to be satisfied;
buffering the first scanned document as a buffered document for a later transmission to the digital receiving device if the set of conditions for the first scanned document have been determined not to be satisfied;
detecting when the set of conditions for the first scanned document have been satisfied;
transmitting the buffered document to the digital receiving device after the set of conditions for the first scanned document have been detected to have been satisfied;
determining whether a set of conditions for a second scanned document have been satisfied;
transmitting the second scanned document to a second digital receiving device if the set of conditions for the second scanned document have been determined to be satisfied;
buffering the second scanned document as a buffered document for a later transmission to the digital receiving device if the set of conditions for the second scanned document have been determined not to be satisfied;
detecting when the set of conditions for the second scanned document have been satisfied; and
transmitting the buffered document to the digital receiving device after the set of conditions for the second scanned document have been detected to have been satisfied.

20. A computer readable storage medium containing computer instructions for:
determining whether a set of conditions for a scanned document have been satisfied; and
transmitting the scanned document to a digital receiving device if the set of conditions for the scanned document have been determined to be satisfied.

21. The computer readable storage medium in 20 further containing computer instructions for:
buffering the scanned document as a buffered document for a later transmission to the digital receiving device if the set of conditions for the scanned document have been determined not to be satisfied.

22. The computer readable storage medium in 21 further containing computer instructions for:
detecting when the set of conditions for the scanned document have been satisfied; and
transmitting the buffered document to the digital receiving device after the set of conditions for the scanned document have been detected to have been satisfied.

23. A computer readable storage medium containing computer instructions for:
determining whether a set of conditions for a first scanned document have been satisfied;
transmitting the first scanned document to a digital receiving device if the set of conditions for the first scanned document have been determined to be satisfied;
determining whether a set of conditions for a second scanned document have been satisfied; and
transmitting the second scanned document to a second digital receiving device if the set of conditions for the second scanned document have been determined to be satisfied.

24. A computer readable storage medium containing computer instructions for:
determining whether a set of conditions for a first scanned document have been satisfied;
transmitting the first scanned document to a digital receiving device if the set of conditions for the scanned document have been determined to be satisfied;
buffering the first scanned document as a buffered document for a later transmission to the digital receiving device if the set of conditions for the first scanned document have been determined not to be satisfied;
detecting when the set of conditions for the first scanned document have been satisfied;
transmitting the buffered document to the digital receiving device after the set of conditions for the first scanned document have been detected to have been satisfied;
determining whether a set of conditions for a second scanned document have been satisfied; and
transmitting the second scanned document to a second digital receiving device if the set of conditions for the second scanned document have been determined to be satisfied.
